(19) United States
(12) Patent Application Publication
(10) Pub. No.: US 2026/0093135 A1
(43) Pub. Date: Apr. 2, 2026

(54) MODULATION MODULE, OPTICAL MODULATOR, AND OPTICAL DEVICE

(71) Applicant: HON HAI PRECISION INDUSTRY CO., LTD., New Taipei (TW)

(72) Inventor: YU-FONG YU, New Taipei (TW)

(21) Appl. No.: 19/279,319

(22) Filed: Jul. 24, 2025

(30) Foreign Application Priority Data
Sep. 29, 2024 (CN) 202411374066.7

(51) Int. Cl. G02F 1/035; G01S 7/481; G02F 1/03

(52) U.S. Cl. CPC G02F 1/035; G01S 7/4811; G02F 1/0327; G02F 2202/20; G02F 2202/30

(57) ABSTRACT

Embodiments of the present disclosure relate to a modulation module, an optical modulator and an optical device. The modulation module includes a substrate and a modulation interface layer on the substrate. The modulation interface layer has a plurality of modulation regions, and each modulation region changes a phase and/or a polarization direction of the incident light by a varied degree or by a same degree.

### FIELD

The subject matter herein generally relates to the field of meta surfaces, specifically modulation modules, optical modulators using the modulation modules, and optical devices using the optical modulators.

### BACKGROUND

In optical devices, phase retarders or polarization elements are usually added to change the phase and direction of polarization, scanning galvanometers are added to deflect light, and lenses or freeform mirrors are added to eliminate aberrations or chromatic aberrations. However, the introduction of phase retardants, polarizing elements, rotating mirrors, lenses, or freeform mirrors increases the volume and energy consumption of the optical device.

Therefore, there is room for improvement in the art.

### BRIEF DESCRIPTION OF THE DRAWINGS

Implementations of the present disclosure will now be described, by way of embodiment, with reference to the attached figures.

FIG. 1 is a schematic structural view of an optical modulator according to a first embodiment of the present disclosure.

FIG. 2 is a schematic structural view according to a modified embodiment of the optical modulator in FIG. 1.

FIG. 3 is a schematic structural diagram showing modulation regions of the optical modulator in FIG. 1.

FIG. 4 is a schematic structural view of an optical modulator according to a second embodiment of the present disclosure.

FIG. 5 is a schematic structural view showing the optical modulator in FIG. 4, including three modulation modules for transmitting an incident light.

FIG. 6 is a schematic top view of the three modulation modules in FIG. 5.

FIG. 7 is a schematic structural view according to a modified embodiment of the optical modulator in FIG. 4.

FIG. 8 is a functional schematic view of an optical device according to an embodiment of the present disclosure.

FIG. 9 is a functional schematic view of the optical device in FIG. 8 as a LiDAR

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which references indicate similar elements. It should be noted that references to “an” or “one” embodiment in this disclosure are not necessarily to the same embodiment, and such references can mean “at least one”.

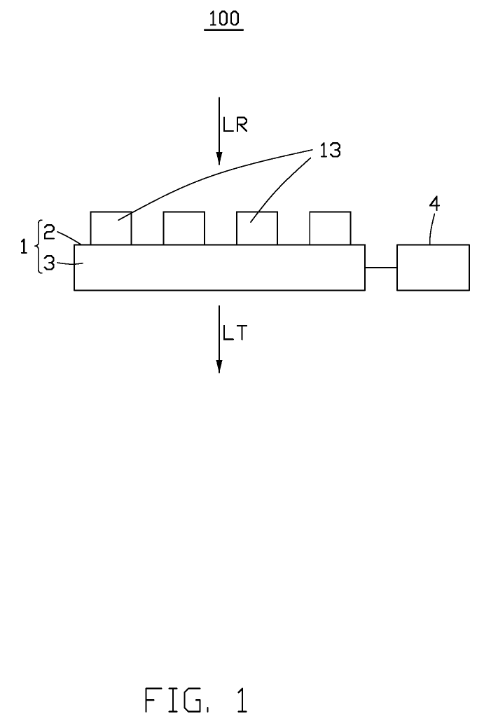

As shown in FIG. 1, an optical modulator 100 includes a modulation module 1. The modulation module 1 includes a modulation interface layer 2 and a substrate 3. The modulation interface layer 2 is on a surface of the substrate 3. The modulation interface layer 2 is configured to receive an incident light LR and change a phase and/or a polarization direction of the incident light LR. The modulation interface layer 2 includes a plurality of modulation regions 10. Each modulation region 10 changes the phase and/or the polarization direction of the incident light LR by a varied degree or by a same degree.

The modulation interface layer 2 includes a plurality of convex nanostructures 13. At least one of a material, a shape and an arrangement of the convex nanostructures 13 in each modulation region 10 is different from each other, so that when the incident light LR passes through different modulation regions 10, the phase and/or polarization direction of the incident light LR can be easily changed according to the use requirements.

The optical modulator 100 further includes a power supply module 4. The power supply module 4 is electrically connected to the power supply module 1. The power supply module 4 can provide a voltage to the modulation module 1.

As shown in FIG. 1, the modulation interface layer 2 is configured to transmit the incident light LR. The modulation module 1 is configured to modulate the incident light LR to a transmitted light LT. A phase and/or a polarization direction of the transmitted light LT is different from the incident light LR.

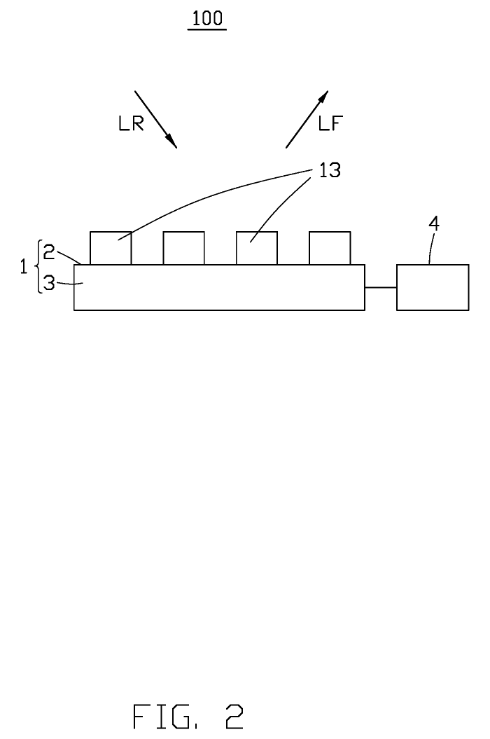

As shown in FIG. 2, the modulation interface layer 2 is configured to reflect the incident light LR. The modulation module 1 is configured to modulate the incident light LR to a reflected light LF. A phase and/or a polarization direction of the reflected light LF is different from the incident light LR.

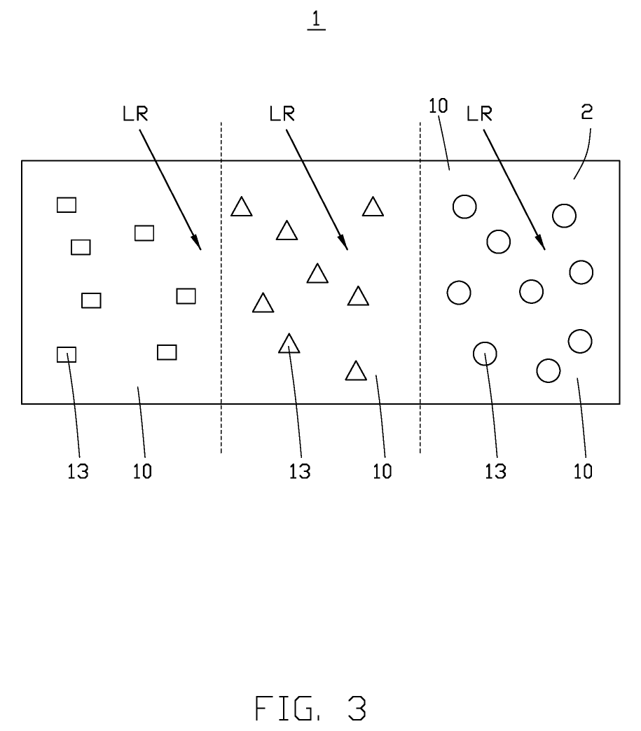

As shown in FIG. 3, the shape of the nanostructures 13 in each modulation region 10 is different from each other, and the arrangement of the convex nanostructures 13 in each modulation region 10 is different from each other. Each modulation region 10 is used to change the phase and/or polarization direction of the incident light LR to the same/different degree.

Specifically, the modulation interface layer 2 includes three modulation regions 10, the materials of the nanostructures 13 in each modulation region 10 are the same, and the arrangement of the nanostructures 13 in each modulation region 10 is irregular.

In other embodiments, the modulation interface layer 2 can include two, four or more modulation regions 10, and the materials of the nanostructures 13 in each modulation region 10 can be different from each other.

In one embodiment, the material of the substrate 3 is silicon, which has high electrical conductivity and low cost. In other embodiments, the material of the substrate 3 can be, but not limited to, indium phosphide, silicon nitride or silicon-based optoelectronics.

In FIG. 1, the shape of each nanostructure 13 is a cuboid. In other embodiments, the shape of each nanostructure 13 can be a sphere, a cylinder, a triangular prism, a quadrangular prism or other polyhedral prism. The resonance wavelength, resonance wavelength width, reflection characteristics, absorption characteristics, and transmission characteristics of light after passing through the nanostructures 13 can be changed according to the material, shape, and arrangement of the nanostructures 13.

The material of the nanostructures 13 can be a metal material with high conductivity and capable of inducing surface plasmon excitation, such as copper (Cu), aluminum (Al), nickel (Ni), iron (Fe), etc., or alloys composed of copper (Cu), aluminum (Al), nickel (Ni), or iron (Fe).

In addition, the material of the nanostructures 13 can be a material with a linear electro-optic effect, such as potassium dihydrogen phosphate (KDP), ammonium dihydrogen phosphate (ADP), lithium niobate (LiNbO), lithium iodate (LiIO) and other crystals without central symmetry.

In other embodiments, the material of the nanostructures 13 can be a piezoelectric material, such as quartz crystals, lithium gallium oxide, lithium germanate, titanium germanate and iron transistors lithium niobate, lithium tantalate and the like. That is, the material of the nanostructures 13 can be a thermo-optical material, and a piezoelectric material or an electro-optical material.

In one embodiment, the nanostructures 13 made of silicon can be deeply etched at low temperature by various etching mask materials such as polymer, chromium (Cr), silicon dioxide and Cr- monomer. Since limiting Cr and silicon dioxide direct hard masks is a key factor in achieving the aspect ratio, and the etching selectivity affects the limitations of the polymer mask. That is, Cr has the same high selectivity to the polymer mask as Cr, which is conducive to reducing the excessive undercutting introduced by the direct hard mask. By optimizing the etching parameters, the nanostructures 13 are processed onto the surface of the substrate 3.

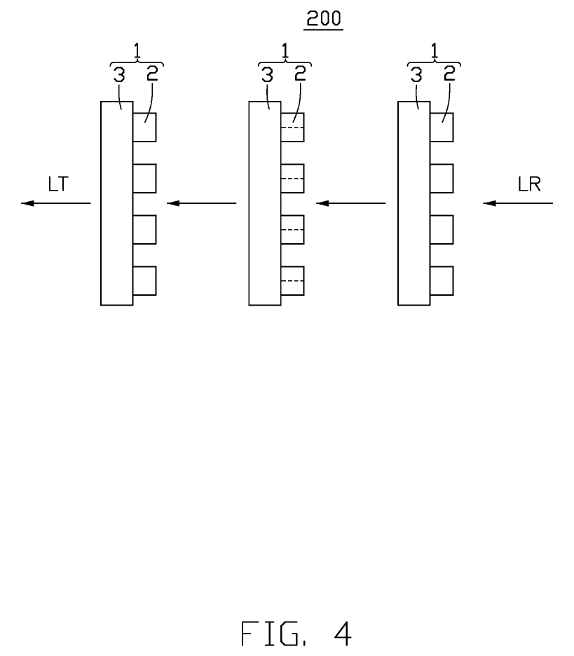

As shown in FIG. 4, an optical modulator 200 includes a plurality of the modulation modules 1. Similar to the optical modulator 100, the optical modulator 200 further includes a power supply module (not shown) electrically connected to the modulation modules 1. The power supply module can provide a voltage to the modulation modules 1. The modulation interface layer 2 of each modulation module 1 is oriented in the same direction and arranged along an optical path of the incident light LR, so that the incident light LR passes through each modulation module 1 in turn.

In FIG. 4, each modulation module 1 is configured to transmit the incident light LR, and each modulation module 1 modulates the incident light LR to a transmitted light LT, and the phase and/or polarization direction of the transmitted light LT is different from the incident light LR.

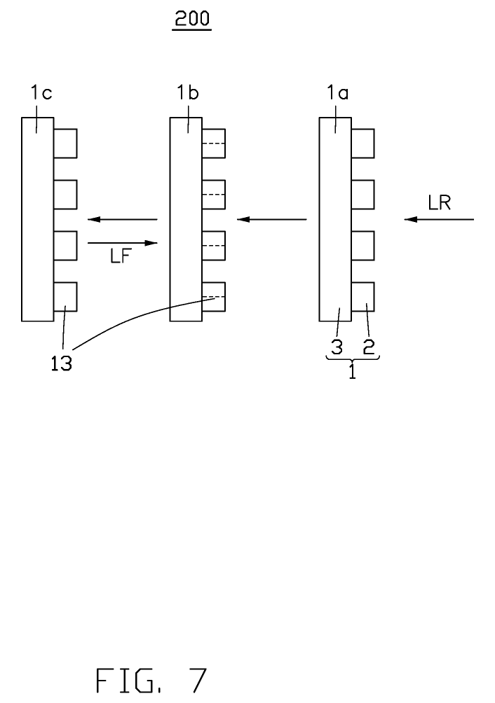

In other embodiments, as shown in FIG. 7, the modulation interface layer 2 of at least one of the modulation modules 1 is configured to reflect the incident light LR and modulate the incident light LR into a reflected light, and the phase and/or polarization direction of the reflected light is different from that of the incident light LR.

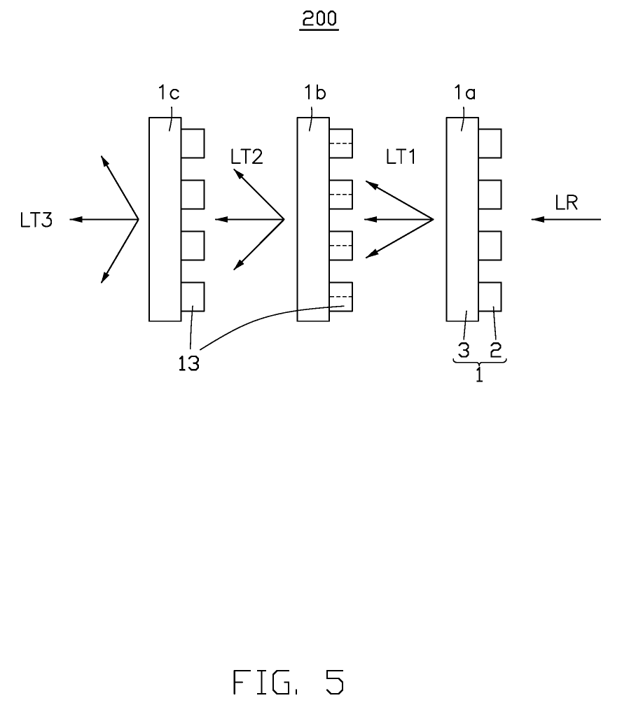

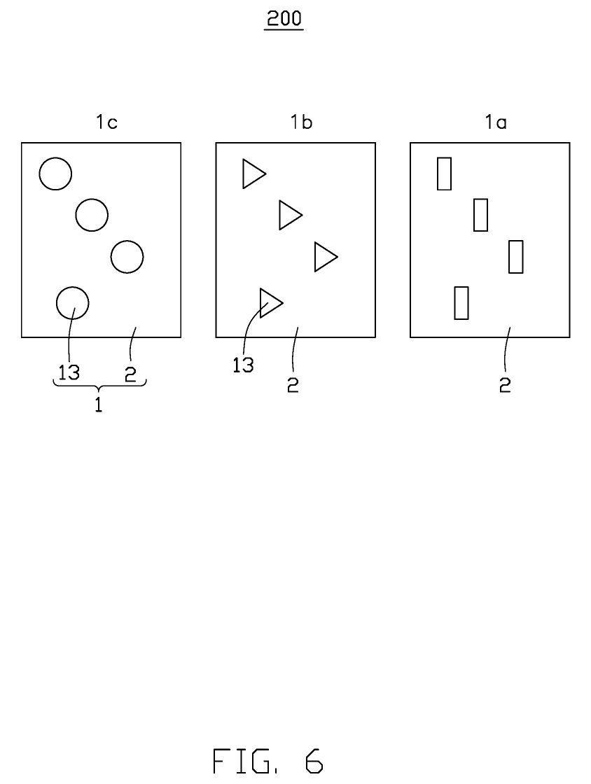

As shown in FIG. 5 and FIG. 6, the optical modulator 200 includes three modulation modules 1. The three modulation modules 1 are a first modulation module 1a, a second modulation module 1b and a third modulation module 1c. The first modulation module 1a, the second modulation module 1b and the third modulation module 1c are arranged at equal intervals in sequence. The shape of the nanostructures 13 of each modulation module 1 is different from each other, and the nanostructures 13 of each modulation module 1 are arranged irregularly on the substrate 3.

The shape of each nanostructure 13 of the modulation module 1a is a cuboid, the shape of each nanostructure 13 of the modulation module 1b is a triangular prism, and the shape of the nanostructure 13 of the modulation module 1c is a cylinder.

The first modulation module 1a is configurated to receive the incident light LR and modulate the incident light LR to a first transmitted light LT1, and the first transmitted light LT1 is deflected by 1° to 6° relative to the incident light LR. The second modulation module 1b is configurated to receive the first transmitted light LT1 and modulate the first transmitted light LT1 into a second transmitted light LT2, and the second transmitted light LT2 is deflected by 3° to 8° relative to the first transmitted light LT1. The third modulation module 1c is configurated to receive the second transmitted light LT2 and modulate the second transmitted light LT2 into a third transmitted light LT3, and the third transmitted light LT3 is deflected by 5° to 10° relative to the second transmitted light LT2.

As shown in FIG. 7, the modulation module 1 is plurality, the optical modulator 200 may include at least one side surface of the modulation module 1 arranged with a nanostructure for reflecting the incident light LR.

In other embodiments, the optical modulator 200 can include two, four or more modulation modules 1. The material and/or shape of the nanostructures 13 of modulation modules 1 may be different from each other. The shape of each nanostructure 13 can be a sphere, a cylinder, a triangular prism or a quadrangular prism, and so on. The arrangement of the nanostructure 13 of each modulation module 1 on the substrate 3 can be, but not limited to, irregular.

The optical modulator 200 is provided with the plurality of modulation modules 1 with the same orientation of the nanostructures 13 arranged in sequence, so that the incident light LR passes through each modulation module 1 in sequence, and the phase and/or polarization direction of the incident light LR can be conveniently changed according to the use requirements, which is conducive to reducing the volume, aberration and chromatic aberration of optical devices using the optical modulator 200.

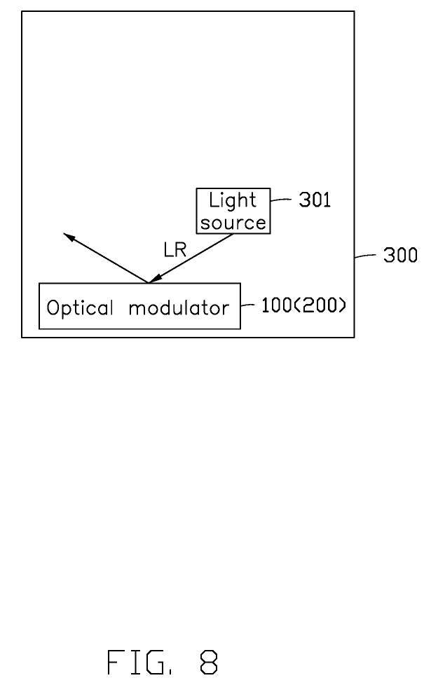

As shown in FIG. 8, an optical device 300 includes a light source 301 and the optical modulator 100 (200). The light source 301 is used to emit the incident light LR. The optical modulator 100 (200) is used to receive the incident light LR emitted by the light source 301 and change the phase and/or polarization direction of the incident light LR. The optical device 300 can be, but not limited to, a virtual reality head mounted display device, an augmented reality headset device, or a head-up display device. For example, the optical device 300 can be an optical ranging device applied to bicycles, ships, automobiles and airplanes. In addition, the optical ranging device can be used in radar, obstacle avoidance, 3D printing, image display, and free space optical communication, and other application fields.

The optical device 300 can change the phase and/or polarization direction of the incident light LR simply and conveniently by applying the optical modulator 100 (200), which is conducive to reducing the volume, the aberration and the chromatic aberration of the optical device 300.

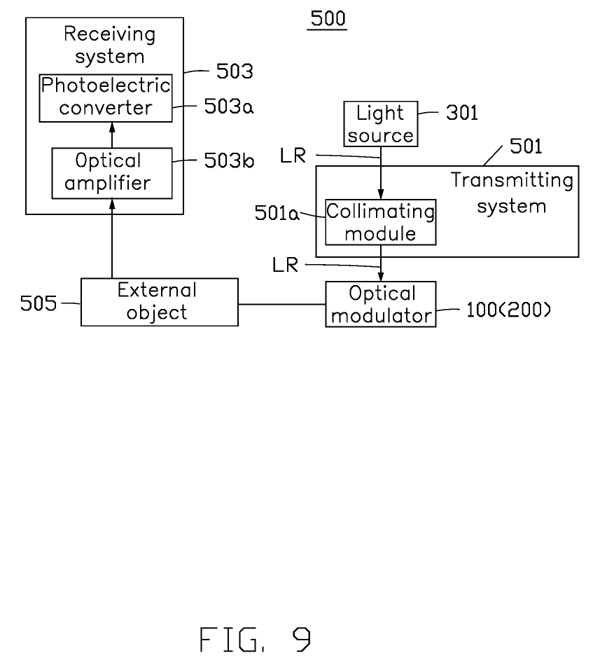

As shown in FIG. 9, the optical device 300 is a LiDAR 500. The optical device 300 further includes a transmitting system 501 and at least one receiving system 503. The transmitting system 501 includes a collimating module 501a for focusing and collimating the incident light LR exiting from the light source 301. The incident light LR then passes through the optical modulator 100 (200). The phase and/or polarization direction of the incident light LR is changed by the optical modulator 100 (200).

The transmitting system 501 is used to receive the incident light LR from the light modulation device 100 (200) and emit the incident light LR into free space. The receiving systems 503 are used to receive the incident light LR reflected from an external object 505 in the free space. The number of modulation regions 10 is the same as the number of receiving systems 503. Each receiving system 503 includes an optical amplifier 503a and a photoelectric converter 503b. The optical amplifier 503a is used for amplifying the optical signal of the incident light LR, and the incident light LR is converted from the optical signal to an electrical signal through the photoelectric converter 503b, so as to facilitate signal processing and data conversion, and facilitate further control and calculation. The lidar 500 using the optical modulator 100 (200) can conveniently adjust the deflection angle of the incident light LR and has a small size and low energy consumption.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. A modulation module configured for an optical modulator comprising:
a substrate; and
a modulation interface layer on a surface of the substrate and configured to receive an incident light and change a phase and/or a polarization direction of the incident light,
wherein the modulation interface layer has a plurality of modulation regions, and each of the plurality of modulation regions changes the phase and/or polarization direction of the incident light by a varied degree or by a same degree.

2. The modulation module of claim 1, wherein the modulation interface layer comprises a plurality of convex nanostructures, and at least one of a material, a shape and an arrangement of the plurality of convex nanostructures in each of the plurality of modulation regions is different from each other.

3. The modulation module of claim 2, wherein the arrangement of the plurality of convex nanostructures in each of the plurality of modulation regions is irregular.

4. The modulation module of claim 2, wherein the material of the plurality of convex nanostructures is a thermo-optical material, a piezoelectric material or an electro-optical material.

5. The modulation module of claim 1, wherein the modulation interface layer is configured to transmit the incident light.

6. The modulation module of claim 1, wherein the modulation interface layer is configured to reflect the incident light.

7. An optical modulator comprising a power supply module and at least one modulation module electrically connected to the power supply module, each of the at least one modulation module comprising:
a substrate; and
a modulation interface layer on a surface of the substrate and configured to receive an incident light and change a phase and/or a polarization direction of the incident light,
wherein the modulation interface layer has a plurality of modulation regions, and each of the plurality of modulation regions changes the phase and/or polarization direction of the incident light by a varied degree or by a same degree.

8. The optical modulator of claim 7, wherein the modulation interface layer comprises a plurality of convex nanostructures, and at least one of a material, a shape and an arrangement of the plurality of convex nanostructures in each of the plurality of modulation regions is different from each other.

9. The optical modulator of claim 8, wherein the arrangement of the plurality of convex nanostructures in each of the plurality of modulation regions is irregular.

10. The optical modulator of claim 8, wherein the material of the plurality of convex nanostructures is a thermo-optical material, a piezoelectric material or an electro-optical material.

11. The optical modulator of claim 7, wherein the at least one modulation module comprises at least two modulation modules, and the modulation interface layer of each of the at least two modulation modules is oriented in a same direction and arranged along an optical path of the incident light, and the modulation interface layer of at least one of the at least two modulation modules is configured to reflect the incident light.

12. The optical modulator of claim 7, wherein the at least one modulation module comprises at least two modulation modules, and the modulation interface layer of each of the at least two modulation modules is oriented in a same direction and arranged along an optical path of the incident light, and the modulation interface layer of each of the at least two modulation modules is configured to transmit the incident light.

13. The optical modulator of claim 7, wherein the at least two modulation modules comprise a first modulation module, a second modulation module and a third modulation module arranged sequentially at equal intervals;
the first modulation module is configurated to receive the incident light and modulate the incident light into a first transmitted light, and the first transmitted light is deflected by 1° to 6° relative to the incident light;
the second modulation module is configurated to receive the first transmitted light and modulate the first transmitted light into a second transmitted light, and the second transmitted light is deflected by 3° to 8° relative to the first transmitted light; and
the third modulation module is configurated to receive the second transmitted light and modulate the second transmitted light into a third transmitted light, and the third transmitted light is deflected by 5° to 10° relative to the second transmitted light.

14. An optical device comprising:
a light source for emitting an incident light;
an optical modulating device comprising a power supply module and at least one modulation module electrically connected to the power supply module, wherein each of the at least one modulation module comprises a substrate and a modulation interface layer, the modulation interface layer is on a surface of the substrate and configured to receive an incident light and change a phase and/or a polarization direction of the incident light, the modulation interface layer has a plurality of modulation regions, and each of the plurality of modulation regions changes the phase and/or polarization direction of the incident light by a varied degree or by a same degree;
a transmitting system for receiving the incident light emitted from the optical modulator and emitting the incident light into free space; and
a plurality of receiving systems for receiving the incident light reflected back from the free space, and each of the plurality of receiving systems corresponds to one of the plurality of modulation regions.

15. The optical device of claim 14, wherein the modulation interface layer comprises a plurality of convex nanostructures, and at least one of a material, a shape and an arrangement of the plurality of convex nanostructures in each of the plurality of modulation regions is different from each other.

16. The optical device of claim 14, wherein the arrangement of the plurality of convex nanostructures in each of the plurality of modulation regions is irregular.

17. The optical device of claim 14, wherein the material of the plurality of convex nanostructures is a thermo-optical material, a piezoelectric material or an electro-optical material.

18. The optical device of claim 14, wherein the at least one modulation module comprises at least two modulation modules, the modulation interface layer of each of the at least two modulation modules is oriented in a same direction and arranged along an optical path of the incident light, and the modulation interface layer of at least one of the at least two modulation modules is configured to reflect the incident light.

19. The optical device of claim 14, wherein the at least one modulation module comprises at least two modulation modules, the modulation interface layer of each of the at least two modulation modules is oriented in a same direction and arranged along an optical path of the incident light, and the modulation interface layer of each of the at least two modulation modules is configured to transmit the incident light.

20. The optical device of claim 14, wherein the at least two modulation modules comprise a first modulation module, a second modulation module and a third modulation module arranged sequentially at equal intervals;
the first modulation module is configurated to receive the incident light and modulate the incident light into a first transmitted light, and the first transmitted light is deflected by 1° to 6° relative to the incident light;
the second modulation module is configurated to receive the first transmitted light and modulate the first transmitted light into a second transmitted light, and the second transmitted light is deflected by 3° to 8° relative to the first transmitted light; and
the third modulation module is configurated to receive the second transmitted light and modulate the second transmitted light into a third transmitted light, and the third transmitted light is deflected by 5° to 10° relative to the second transmitted light.
